(19) United States
(12) Patent Application Publication
(10) Pub. No.: US 2015/0254583 A1
(43) Pub. Date: Sep. 10, 2015

(54) SYSTEMS ANDMETHODS FOR GENERATING TRIGGER NETWORKS CORRESPONDING TO EVENT-CONDITION-ACTION RULES

(71) Applicant: SAP SE, Walldorf (DE)

(72) Inventors: Soeren BALKO, Weinheim (DE); Franz WEBER, Wiesloch (DE); Matthias MILTZ, Heidelberg (DE); Thomas HETTEL, Brisbane (AU)

(21) Appl. No.: 14/720,387

(22) Filed: May 22, 2015

Related U.S. Application Data
(63) Continuation of application No. 12/644,786, filed on Dec. 22, 2009, now abandoned.

(51) Int. Cl. G06Q 10/06

(52) U.S. Cl. CPC G06Q 10/067

(57) ABSTRACT

Systems and methods consistent with the invention may include executing a business task by receiving an instruction to execute a business task; generating an event-condition-action (ECA) rule during execution of the business task; generating a graphical representation corresponding to the ECA rule; and executing, using a processor of the computer system, the business task based on an evaluation of the graphical representation.

### BACKGROUND

1. Relevant Field

Systems and methods consistent with the present invention generally relate to the management of data. More particularly, systems and methods consistent with the invention relate to generating trigger networks to evaluate event-condition-action (ECA) rules outputted by application programs while performing processing tasks.

2. Background Information

Businesses and other organizations generate and/or receive a variety of data items and electronic information (broadly referred to hereafter as “business data”) during the course of their operation. The business data may be generated and/or received from various entities located in different regions and/or countries. To organize and manage operations of the organization, different departments of an organization may run different application programs to manage and process the business data. These application programs may be used for maintenance and storage of the business and/or during operation of complex systems of the organization. Similarly, different organizations may use application programs that differ from other organizations. Moreover, as business operations of an organization increase, the use of different types of application programs for processing business data becomes resource intensive.

While processing data and performing various tasks, application programs may generate event-condition-action (ECA) rules that may need to be processed and evaluated for completion of the tasks. ECA rules may represent business rules that trigger actions from combinations of business events. For example, ECA rules may be used in business activity monitoring (BAIL), complex event processes (CEP), business rules management (BRM), business process management (BPM), declarative/constraint-based status, and action management rules for business entities. An event part of an ECA rule may specify a signal that triggers an invocation of a corresponding rule, and the condition part may indicate a logical test, that if satisfied or evaluated to be true, causes the action to be carried out. For example, the condition may be a first-order logics term on business data and the corresponding action could be updating object attributes of the business data. An action in an ECA rule may produce new events that are fed back into a cycle, and execution of a rule may indirectly trigger an additional rule through the new events.

Conventional systems for evaluating and processing ECA rules may use a syntax that is difficult to comprehend for end users, thus making it difficult for an end user to perform business tasks based on and/or modeled on ECA rules. Further, evaluating ECA rules is a time consuming and costly process. Moreover, conventional techniques for evaluating ECA rules may require the implementation of resource intensive and customized compilers for different application programs of an organization, thus delaying execution of business tasks and increasing the time and cost for business operations.

In view of the foregoing, it is desirable to provide systems and methods for reducing the time and computations required to perform business tasks. For example, there is a need for improved systems and methods for processing ECA rules with efficient algorithms and data structures that may capture semantics of ECA rules in a cost-efficient manner and that use less resource intensive techniques.

### SUMMARY

Consistent with one embodiment of the invention, a method for executing a business process is provided. The method comprises receiving an instruction to execute a business task; generating an event-condition-action (ECA) rule during execution of the business task; generating a graphical representation corresponding to the ECA rule; and executing, using a processor of the computer system, the business task based on an evaluation of the graphical representation.

Consistent with another embodiment of the present invention, there is provided a computer-readable storage medium including instructions which, when executed on a processor, cause the processor to perform a method of executing a business process. The method comprises receiving an instruction to execute a business task; generating an event-condition-action (ECA) rule during execution of the business task; generating a graphical representation corresponding to the ECA rule; and executing, using a processor of the computer system, the business task based on an evaluation of the graphical representation.

Consistent with another embodiment of the present invention, there is provided a system for executing a business process. The system comprises a memory device having instructions; and a processor executing the instructions to perform the steps of receiving an instruction to execute a business task; generating an event-condition-action (ECA) rule during execution of the business task; generating a graphical representation corresponding to the ECA rule; and executing, through use of the processor, the business task based on an evaluation of the graphical representation.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary layered system of an organization, consistent with the present invention;

FIG. 2 illustrates an exemplary system for performing execution of a business process by evaluating ECA rules based on graphical representations, consistent with the present invention;

FIG. 3 illustrates an exemplary graphical representation used to evaluate a condition of an ECA rule, consistent with the invention;

FIG. 4 illustrates an exemplary graphical representation used to evaluate an additional condition of an additional ECA rule, consistent with the invention;

FIG. 5 illustrates an exemplary graphical representation used to evaluate an additional condition of an ECA rule, consistent with the invention;

FIG. 6 illustrates an exemplary graphical representation used to evaluate an additional condition of an ECA rule, consistent with the invention; and

FIG. 7 illustrates a flowchart illustrating an exemplary process 700 for performing a business task based on an evaluation of ECA rules, consistent with the present invention.

### DETAILED DESCRIPTION

The following detailed description refers to the accompanying drawings. Wherever possible, the same reference numbers are used in the drawings and in the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods consistent with the invention generally relate to an execution of business processes by evaluating event-condition-action (ECA) rules generated by application programs run by organizations to execute the business processes. The application programs may be programmed and modeled in accordance with a notation such as Business Process Modeling Notation (BPMN), Java, C++, and/or other similar modeling notations, Exemplary processing engines that may be used in systems consistent with the invention include those offered by SAP AG, such as SAP NetWeaver Business Process Management (BPM). SAP NetWeaver BPM may efficiently model, execute, and monitor business processes based on a common process model. SAP NetWeaver SPM may be used to compose process steps, define business rules and exceptions, model process flows using various business process modeling notations, execute process models by generating and evaluating ECA rules, monitor business processes, and/or support interaction with running processes via personalized user interfaces or interactive forms.

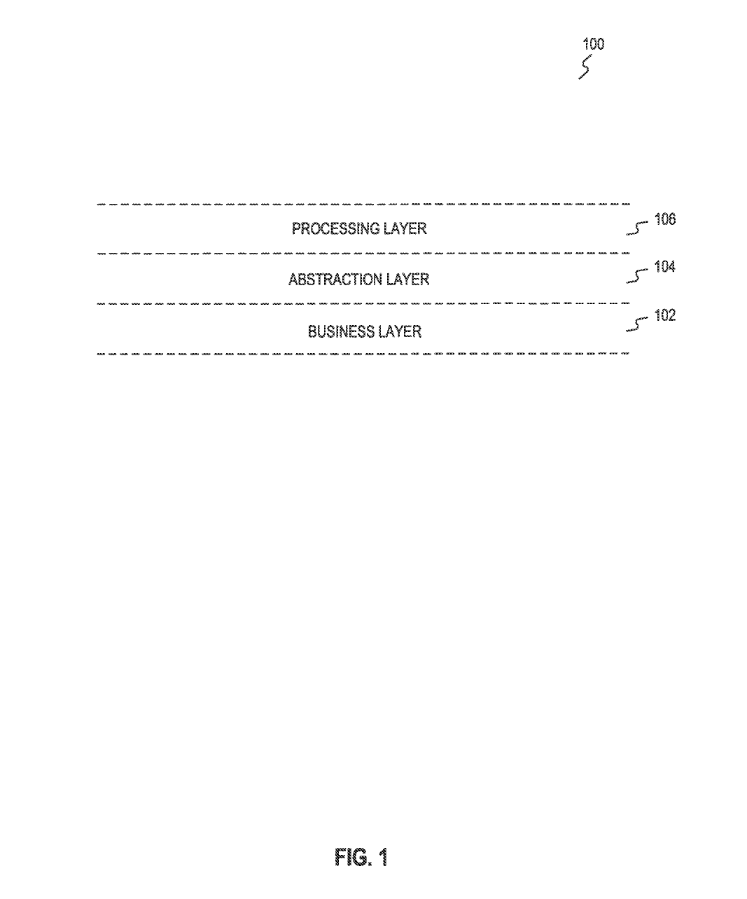

For example, as shown in FIG. 1, an exemplary organization 100 may be divided into multiple layers, based on their operations. Organization 100 may have a business layer 102 that depicts business operations of organization 100. These business operations may include implementation of communication systems, operation of manufacturing plants, arrangement of supplies for the manufacturing process, shipping of manufactured products, sales and marketing of these products, and/or additional operations. Organization 100 may also include an abstraction layer 104 that depicts the business data that is extracted from systems run in business layer 102. The extracted business data may be raw data that has not yet been manipulated or processed, and is then processed in a processing layer 106 of organization 100. Processing layer 106 may include various components including hardware and software, and may be used to implement, for example, SAP NetWeaver BPM.

Processing layer 100 may use application programs to generate ECA rules based on the business data in extraction layer 104. These ECA rules may be processed and evaluated to ensure that business operations being run in business layer 102 are being executed, By using processing layer 106, a user in organization 100 may use processed business data to monitor and deduce information regarding business operations of organization 100. As is described in further detail below, application programs in processing layer 106 may generate graphical representations such as trigger networks to evaluate ECA rules and to ensure efficient execution of business process in organization 100.

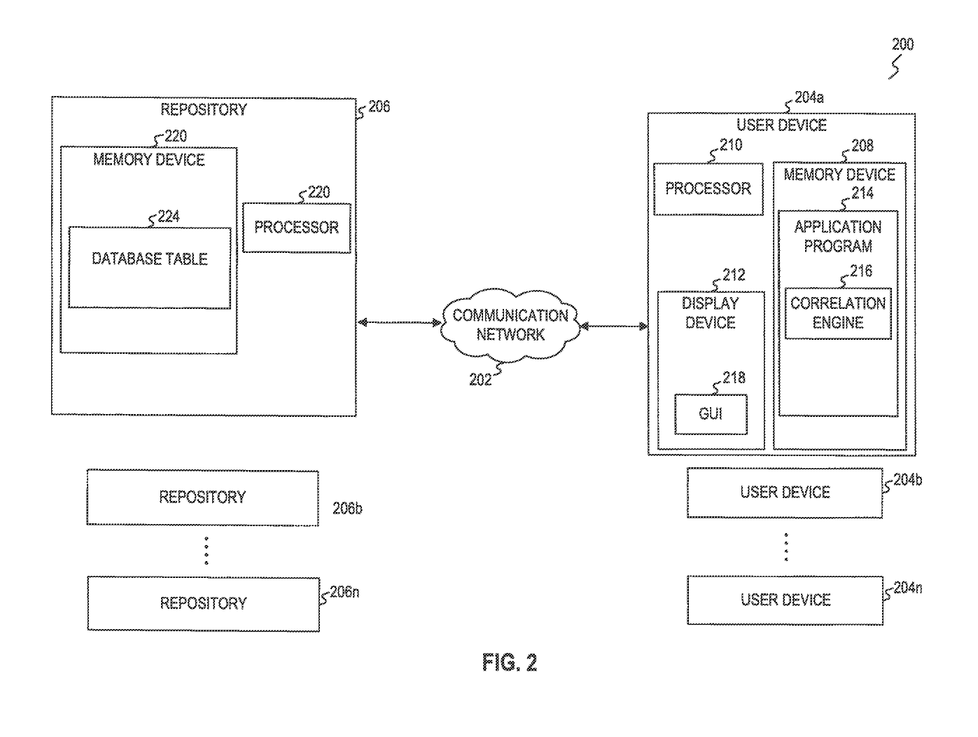

FIG. 2 is a system 200 for performing run-time execution of a business process by evaluating ECA rules based on graphical representations. As shown in FIG. 2, system 200 includes a communication network 202 that facilitates communication between a plurality of nodes 204a-n and 206a-n. Communication network 202 may include one or more network types, such as a wide-area network (WAN), a local-area network (LAN), or the Internet. Communication network 202 may operate by wireline and/or wireless techniques and may use transmission control protocol/internet protocol (“TCP/IP”) or any other appropriate protocol to facilitate communication between nodes 204a-n and 206a-n of system 200. Network connections between the nodes of system 200 may be established via Ethernet, telephone line, cellular channels, or other transmission media.

Nodes of system 200 may comprise a combination of one or more application programs and one or more hardware components. For example, application programs may include software modules, sequences of instructions, routines, data structures, display interfaces, and other types of structures that, when executed by a hardware component (as described below), execute operations consistent with the present invention. The hardware components may include a combination of central processing units (CPUs), buses, memory devices, storage units, data processors, input devices, output devices, network interface devices, and other types of components that will become apparent to those skilled in the art.

Consistent with an embodiment of the present invention, nodes 204a-n and 206a-n of system 200 may be respectively implemented by using user devices and repositories. User device 204a may be an appropriate device for sending, receiving, processing, and presenting data. For example, user device 204a may include personal computers, workstations, mainframe computers, notebooks, global positioning devices, and handheld devices such as cellular phones and personal digital assistants.

As is illustrated in FIG. 2, user device 204a may include a memory device 208, a processor 210, and a display device 212. Memory device 208 may be used to store instructions, such as an application program 214, which may be executed by processor 210 to cause user device 204a to implement a plurality of operations. Application program 214 may be used to implement a business processing engine such as SAP NetWeaver BPM, and may include instructions for the implementation of a compiler 216 and a correlation engine 226. Compiler 216 may process data corresponding to ECA rules and may generate a graphical representation based on the processed data. The graphical representation may be provided to correlation engine 226 for evaluation of ECA rules. Display device 212 may be used to implement a graphical user interface (GUI) 218 to allow a user of user device 204a to interface with at least a portion of system 200. For example, graphical user interface 218 may display data generated by application program 214. User device 204a may also include additional components such as input and output devices (not shown), and user devices 204b-n may also include memory devices, processors, and application programs as described above with respect to user device 204a.

User devices 204a-n may communicate with repositories 206a-n via communication network 202. Repositories 206a-n may be used to classify, manage, and store data. Repositories 206a-n may be located in different regions and may comprise a database management system such as SAP NetWeaver BPM from SAP AG, Repository 206a may include a memory device 220 and a processor 222, Memory device 220 may store business data and data objects in database table 224 that may be received during execution of business processes of an organization.

Memory device 220 may also include application programs (not shown) that may be executed on processor 222 for management, maintenance, and retrieval of data stored in memory device 220. Repositories 206b-n may also include memory devices, application programs, and processors. Communication between user devices 204a-n and repositories 206a-n may include sending data, such as requests and queries to repository 206a, and receiving data, such as data objects from database table 224.

Although the exemplary embodiment of system 200 is described as having particular components arranged in a particular manner, one skilled in the art will appreciate that system 200 may include additional or fewer components that may be arranged differently. For example, user devices 204a-n and repositories 206a-n may include additional processors and/or memory devices or user device 204a may be implemented as a standalone station. System 200 may also be implemented in a client/server arrangement, and the server may include hardware and software components. Memory devices 208 and 220 may include all forms computer-readable storage mediums such as non-volatile or volatile memories including, by way of example, semiconductor memory devices, such as EPROM, RAM, ROM, DRAM, EEPROM, and flash memory devices; magnetic disks such as internal hard disks and removable disks; magneto-optical disks; and CD-ROM disks.

During execution of a business task, application program 214 may be executed on processor 210, and may generate ECA rules during the execution. For example, user device 204a may send data objects to repository 206a, via communication network 202, that may be generated based on an execution of application program 214. The ECA rules may identify constraints of database table 224 that may need to be resolved and evaluated for storage of the data objects in the database table 224. Similarly, ECA rules may also be generated during additional executions of application program 214 while performing various business operations and/or may be manually provided by a user of user device 204a.

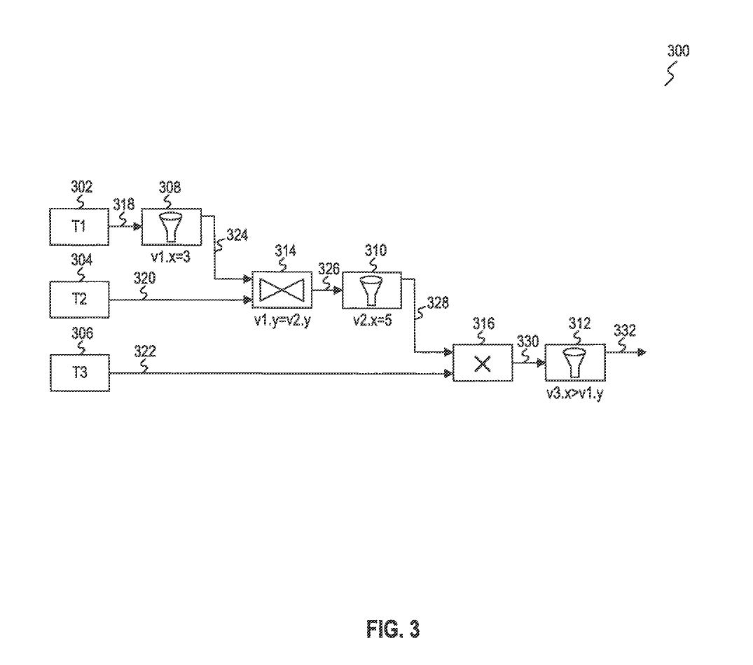

As is described in further detail below with respect to FIGS. 3 to 6, compiler 216 may generate a graphical representation corresponding to the ECA rules and correlation engine 226 may use the graphical representation to evaluate the ECA rules. The graphical representation may be a trigger network used to resolve the conditions of the ECA rules, A trigger network may be a graph based on the RETE algorithm that may be used for processing event-condition-action rules in a transactional manner. The RETE algorithm is an efficient pattern-matching algorithm for implementing production rule systems, and may be used to generate a RETE-graph, A system implementing a RETE-graph may build a network of nodes, where each node may correspond to a pattern occurring in a condition of a rule. The path from the root node to a leaf node may define a complete rule and each node may include a memory of facts that may satisfy the pattern. When a fact or combination of facts causes patterns for a given rule to be satisfied, a leaf node may be reached and a corresponding rule is triggered. A RETE-graph is a data structure including operator nodes and describes the order in which the graph may be traversed in order to check a condition. The trigger network may be a variant of a RETE-graph and may differ from a RETE-graph such that states are preserved over successive transactions in a trigger network and conditions are conceptually expressed in trigger network.

Further, a trigger network may include source nodes representing types of events, operator nodes representing atomic conditions, and target nodes representing actions. Additional examples of operators included in a trigger network may be filter operators, join operators, switch operators, swizzle operators, and/or Cartesian product operators.

For example, application program 214 may generate an ECA rule that may include a condition defined as:

c≡(∃T₁v₁)f₁(v₁)o₁(∃ [symbol] )T₂v_{z})o₂ . . . oₙ₋₁(∃, [symbol] )Tₙvₙ)f₃(v₁,v₂, . . . vₙ) (1)

In equation 1, C may represent a condition in an ECA rule. Condition “C” may be a first-order logics term where variables v₁, v₂, and vₙ correspond to data records or tuples of attributes. Variables v₁, v₂, and vₙ may be of a particular type, T, which is represented in equation 1 by T₁, T₂, and Tₙ. Data types T₁, T₂, and Tₙ may define the structure and bound of variables v₁, v₂, and vₙ based on existential and/or universal quantifiers. Attributes of variables v₁, v₂, and vₙ may be compared to other attributes represented in a first-order logics equation that is a propositional expression. As is indicated in equation 1, instances of variables T and v may be bound together such that T₁ is in a binding with v₁, T₂ is in a binding with v₂, and Tₙ is in a binding with vₙ. As will be explained below, the terms f₁, f₂, and f₃ may represent Boolean formulae in Disjunction Normal Form (DNF) that incorporate the variables v₁, v₂, and vₙ.

Before generating a graphical representation corresponding to the condition C and mapping the ECA rule into a trigger network, compiler 216 may be executed on processor 210 to perform a preparation step. During the preparation, compiler 216 may normalize the condition C into a canonical form referred to as Trigger Network Normal Form (TNNF), Normalizing condition C into TNNF may make it more suitable for compiler 216 to generate a corresponding graphical representation such as a trigger network. Compiler 216 may perform transformations on condition C to eliminate universal quantifications. Eliminating universal quantifications may include removing “forall” quantifiers from condition C, This may include eliminating duplicate bindings of the same variable symbol, and recursively removing the quantifiers by applying the following rules:

−(∀Tv)φ≡(∃Tv)−φ

( [symbol] Tv)φ≡(∀Tv)−φ

((QTv)φ)(ψ)≡(QTv) (2)

In equation 2, v is a variable of type I and t is a quantifier from (∀, ∃), and o is a Booelan connective from { [symbol] , [symbol] }. After applying the rules represented in equation 2, a propositional part of condition C may be transformed into Conjunctive Normal Form (CNF) by recursively applying the following using compiler 216:

−−φ≡φ (double negation)

−(φ [symbol] ψ)≡−φ [symbol] −ψ

−(φ [symbol] ψ)≡−φ [symbol] −ψ(de Morgan's laws)

φ [symbol] (ψ [symbol] ξ)≡(φ [symbol] ψ) [symbol] (φ [symbol] ξ)

φ [symbol] (ψ [symbol] ξ)≡(φ [symbol] ψ) [symbol] (φ [symbol] ξ) (distributivity) (3)
Once rules in equations 2 and 3 are applied to condition C, compiler 216 may convert the condition into a Prenex Conjunctive Normal Form (PCNF) defined as:

$$( ∃ {T}_{1} {v}_{1} ) ( \{ ∃ , ∄ \} {T}_{2} {v}_{2} … ( \{ ∃ , ∄ \} {T}_{n} {v}_{n} {}_{j} {}_{k} {}_{j , k} \qquad ( 4 )$$

in equation 4, base predicate φ_{j,k} may represent an atomic comparison performed by compiler 216. The comparison may be between, for example, state variable attribute v_{j,k,1}·attr_{j,k,1} and a constant c_{j,k} or another attribute v_{j,k,2}·attr_{j,k,2}. The comparison may be represented as:

$${}_{j , k} ≡ {v}_{j , k , 1} \cdot {attr}_{j , k , 1} θ \{ \begin{matrix}{c}_{j , k} & ( constant comparison ) \\ {v}_{j , k , 2} \cdot {attr}_{j , k , 2} & ( attribute comparison )\end{matrix} \qquad ( 5 )$$

Compiler 216 may choose a comparison operator from φε{=, ≠, >, ≧, <, ≦}, and may eliminate negations on top of base predicates in the PCNF condition by substitution the comparison operator. θ with its inverse as indicated in equation 6:

$$θ = \{ \begin{matrix}\neq if θ is = \\ = if θ is \neq \\ \geq if θ is < \\ > if θ is \leq \\ \leq if θ is > \\ < if θ is \geq \end{matrix} \qquad ( 6 )$$

After performing the comparisons represented by, for example, equation 5 and eliminating the negations represented by, for example, equation 6 compiler 216 may perform normalization by processing nested quantifiers from left to right for each binding ({∀, [symbol] }Tᵢcᵢ) in condition C. Compiler 216 may perform the normalization by extracting sub terms fₗ(v₁, . . . , vₗ) from corresponding bindings that exclusively relate variables bound by vₗ or any outer quantifiers (v₁, . . . vᵢ₋₁). Compiler 216 may extract the sub terms by applying the following:

(QᵢTᵢvᵢ)ψ [symbol] φ(vᵢ)≡ψ [symbol] (QᵢTᵢvᵢ)φ(vᵢ) (7)

Compiler 216 may further eliminate universal quantifiers from condition C by using the following:

(∀T₁v₁)ψ≡(∃T₁v₁)−ψ (8)

Compiler 216 may transform each propositional sub predicate fₗ, included in a PCNF condition, into Disjunctive Normal Form (DNF). An example of this transformation may be represented as follows:)

(∃T₁v₁)(∀T₂v₂)(∃T₃v₃))v₁·x>2 [symbol] v₂·x=v₁·y) [symbol] (v₁·x<8) [symbol] (v₂·x=v₃·x [symbol] v₁·y)=9) [symbol] v₁·y>0 [symbol] v₁·x>0=(∃T₁v₁)(v₁·x<8) [symbol] (v₁·y>0 [symbol] v₁·x>0) [symbol] (∀T₂v₂)(v₁·x>2 [symbol] v₂·x=v₁·y) [symbol] (∃T₃v₃))(v₂·x=v₃·x [symbol] v₁·y=9) (9)

Compiler 216 may eliminate universal quantifiers from the DNF condition and replace the universal quantifiers with negated existential quantifiers. An example of this replacement may be represented as follows:

$$( ∃ {T}_{1} {v}_{1} ) ( {v}_{1} \cdot x < 8 ) ( {v}_{1} \cdot y > 0 {v}_{1} \cdot x > 0 ) ( ∀ {T}_{2} {v}_{2} ) ( {v}_{1} \cdot x > 2 {v}_{2} \cdot x = {v}_{1} \cdot y ) ( ∃ {T}_{3} {v}_{3} ) ( {v}_{2} \cdot x = {v}_{3} \cdot x {v}_{1} \cdot y = 9 ) = ( ∃ {T}_{1} {v}_{1} ) ( {v}_{1} \cdot x < 8 ) ( {v}_{1} \cdot y > 0 {v}_{1} \cdot x > 0 ) ( ∄ {T}_{2} {v}_{2} ) [ ( {v}_{1} \cdot x > 2 {v}_{2} \cdot x = {v}_{1} \cdot y ) ( ∃ {T}_{3} {v}_{3} ) ( {v}_{2} \cdot x = {v}_{3} \cdot x {v}_{1} \cdot y = 9 ) ] = ( ∃ {T}_{1} {v}_{1} ) ( {v}_{1} \cdot x < 8 ) ( {v}_{1} \cdot y > 0 {v}_{1} \cdot x > 0 ) ( ∄ {T}_{2} {v}_{2} ) ( {v}_{1} \cdot x > 2 {v}_{2} \cdot x = {v}_{1} \cdot y ) ( ∄ {T}_{3} {v}_{3} ) ( {v}_{2} \cdot x = {v}_{3} \cdot x {v}_{1} \cdot y = 9 ) = ( ∄ {T}_{1} {v}_{1} ) ( {v}_{1} \cdot x < 8 ) ( {v}_{1} \cdot y > 0 {v}_{1} \cdot x > 0 ) ( ∄ {T}_{2} {v}_{2} ) ( {v}_{1} \cdot x \leq 2 {v}_{2} \cdot x \neq {v}_{1} \cdot y ) ( ∄ {T}_{3} {v}_{3} ) ( {v}_{2} \cdot x = {v}_{3} \cdot x {v}_{1} \cdot y = 9 ) \qquad ( 10 )$$

By performing the foregoing exemplary steps, compiler 216 may generate a normalized condition C in TNNF. The TNNF condition C may be defined as:

(∃T₁v₁)(v₂·x<8) [symbol] (v₁·y>0 [symbol] v₁·x>0) [symbol] (∃T₂v₂)(v₁·x≦2 [symbol] v₂·x≠v₁·y) [symbol] ( [symbol] T₃v₃)(v₂·x=v₃·x [symbol] v₁·y=9)=(∀T₁v₁)[v₁·x<8 [symbol] v₁·y>0) [symbol] (v₁·x<8 [symbol] v₁·x>0)] [symbol] ( [symbol] T₂v₂)(v₁·x≦2 [symbol] v₂·x≠v₁·y) [symbol] ( [symbol] T₃v₃)(v_{2·}x=v_{3·}x [symbol] v_{1·}y=9) (11)

Compiler 216 may, thus, transform a condition C from an exemplary expression defined in equation 1 to an exemplary TNNF expression defined in equation 11. The transformation may be performed to ensure a strict nesting of scopes that relate to variables bound by quantifiers included in a condition. Further, the transformation may be performed to eliminate logical negations and to define the condition as a propositional DNF term connected to a successive quantifier through a logical disjunction or conjunction.

Compiler 216 may use the TNNF expression condition to generate a corresponding graphical representation. The graphical representation may be a trigger network used by correlation engine 226 to evaluate a corresponding condition. For example, compiler 216 may generate the following condition C in TNNF form:

$$𝒞 ≡ ( ∃ {T}_{1} {v}_{1} ) ( ∃ {T}_{2} {v}_{2} ) ( ∃ {T}_{3} {v}_{3} ) {v}_{1} \cdot x = 3 {v}_{1} \cdot y = {v}_{2} \cdot y {v}_{2} \cdot x = 5 {v}_{3} \cdot x > {v}_{1} \cdot y ≡ ( ∃ {T}_{1} {v}_{1} ) {v}_{1} \cdot x = 3 ( ∃ {T}_{2} {v}_{2} ) {v}_{1} \cdot y = {v}_{2} \cdot y {v}_{2} \cdot x = 5 ( ∃ {T}_{3} {v}_{3} ) {v}_{3} \cdot x > {v}_{1} \cdot y \qquad ( 12 )$$

As noted above, condition C represented by equation 12 may include variable v₁, v₂, and v₃ of types T₁, T₂, and T₃. Further, the attributes of variables v₁, v₂, and v₃ may be represented by x, y, and z in equation 12. The condition C represented by equation 12 may include existential quantifiers and logical conjunctions, and may not include negated existential quantifiers. Compiler 216 may generate a graphical representation corresponding to the condition by traversing the condition from an outermost quantifier to an innermost quantifier, and by determining corresponding scopes of the quantifiers. For example, compiler 216 may determine a set of base predicates and may apply a heuristic to selectively determine corresponding operators to be used to represent the base predicates in the generated graphical representation. After selecting base predicates and corresponding operators, compiler 216 may link the operators and generate a graphical representation such as a trigger network.

An exemplary algorithm that may be used by compiler 216 to generate a graphical representation corresponding to the condition C represented in equation 12 may be as follows:

Algorithm 1
Algorithm 1 all(N, C) (handling conjunctions and existential quantification)

```
Require: N is as given network fragment, C is as TNNF predicate where all variables v₁,v₂,. . .
  are existentially quantified,
  and each fᵢ is a conjunct of base predicates [symbol] , φ_{i,j}
Ensure: N incorporates the somantics of C
  1: for i = 1 to n do
  2: let Sᵢ be the set or base prodicates in fᵢ (for vᵢ)
  3: while for vᵢ there are any unhandled base predicates (Sᵢ ≠ θ) do
  4: choose next base predicate: φ ← pick(N)Sᵢ
  5: remove φ from Sᵢ: Sᵢ ← Sᵢ \ {φ}
  6: if N already captures vᵢ then
  7: create a plain filter operator N ← σ_{φ} (N)
  8: else {N does not yet capture vᵢ}
  9: if φ is a constant comparison: φ ≡ vᵢ.attr θ c
          or an attribute comparison: φ ≡ vᵢ.attr θ vᵢ′.attr with θ ε { ≠, <, ≦, >, ≧ } or i^{′} ≡ i then
10: create a Cartesian product - filter operator sequence: N ← σ_{φ}(Tᵢ><N)
11: else
12: create a join operator: N ← T, [symbol]   _{φ}N
13: end if
14: end if
15: end while
16: end for
17: return N
```

Compiler 216 may execute steps included in Algorithm 1 to generate a graphical representation of condition C and may store the graphical representation in memory device 208. In the alternative, compiler 216 may provide the graphical representation to correlation engine 226, and correlation engine 226 may use the graphical representation to evaluate the condition during runtime operations performed by user device 204a.

As is described in further detail below with respect to FIGS. 3-6, compiler 216 may also generate graphical representations for more complex conditions by executing a variation of Algorithm 1. For example, when a condition includes a disjunction, compiler 216 may continue to traverse quantifiers from an outermost quantifier to an innermost quantifier in the condition. In addition to selecting an operator for each base predicate of the quantifier, compiler may also select operators for conjunctions of atomic predicates connected by using the disjunctions. The operators may be selected by separating disjoint cases and by using left inhibitor outputs, right inhibits outputs, and join operators.

Compiler 216 may also generate a graphical representation for a condition that includes a universal quantification represented as a negated existential quantification in TNNF form. Compiler 216 may process the negated existential quantifier by using an extra join operator and a left inhibitor output to connect the negated existential quantifier with a predecessor fragment in the graphical representation. In addition, disjunctions in such a condition may be processed by separating disjoint cases and by using left inhibitor outputs, right inhibits outputs, and join operators. As described below, graphical representations generated by compiler 216 and used by correlation engine 226 may be represented as trigger networks 300, 400, 500, and 600 illustrated in FIGS. 3, 4, 5, and 6, respectively.

For example, FIG. 3 illustrates an exemplary graphical representation that may be represented as trigger network 300. Trigger network 300 may be generated by, for example, compiler 216, and may correspond to the condition C defined in Equation 12 above. As is illustrated in FIG. 3, trigger network 300 may include source nodes 302, 304, and 306; filter operators 308, 310, and 312; join operator 314; a Cartesian product operator 316; and branches 318, 320, 322, 324, 326, 328, 330, and 332. Source node 302 may correspond to data type T₁ and all events related to variables of type T₁ included in condition C. Source node 304 may correspond to data type T₂ and all events related variables of type T₂ included in condition C. Source node 306 may correspond to data type T₃ and all variables of type T₃ included in condition C. Filter operator 308 may correspond to base predicate v₁·x=3 included in subset S₁ generated by compiler 216, filter operator 310 and join operator 314 may correspond to base predicates v₂·x=5 and v₁·y=v₂·y that is included in subset S₂ generated by compiler 216, and filter operator 312 may correspond to base predicate v₃·x>v₁·y included in subset S₃ generated by compiler 216.

Branch 318 may be used to connect source node 302 with filter operator 308, and an output of filter operator 308 may be connected to an input of join operator 314 via branch 324. Similarly, branch 320 may be used to connect source node 304 to a second input of join operator 314. An output of join operator 314 may be connected to an input of filter operator 314 via branch 326, and an output of filter operator 310 may be connected to an input of Cartesian product operator 316 via branch 328. Branch 322 may be used to connect source node 306 and a second input of Cartesian product operator 316. Branch 330 may be used to connect Cartesian product operator 316 to filter operator 312, and an output of filter operator 312 may be provided on branch 332. Thus, after receiving an ECA rule, correlation engine 216 may generate a corresponding trigger network 300 to evaluate a condition and to complete execution of a business task that requires the processing of an ECA rule.

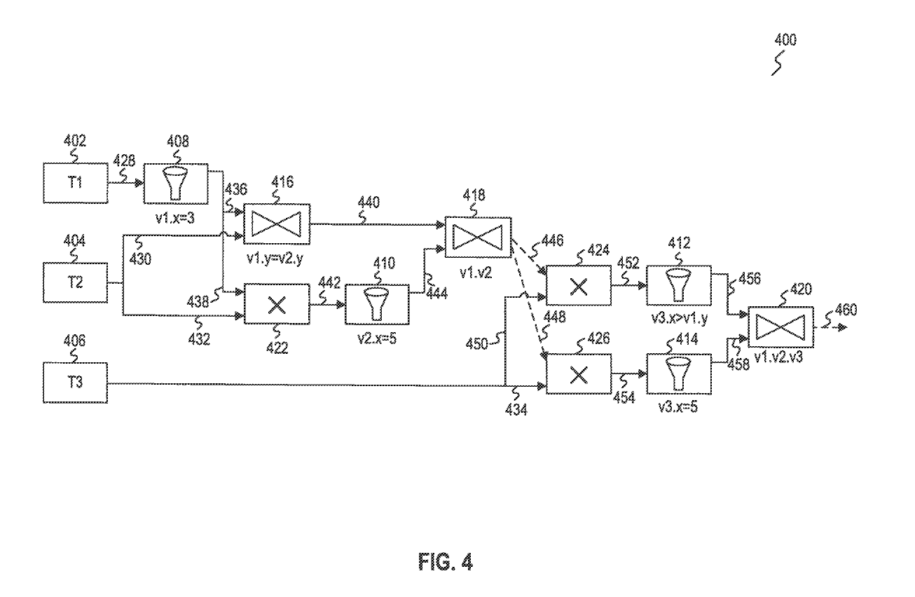

FIG. 4 illustrates an exemplary trigger network 400 that may be used to evaluate a condition included in an additional ECA rule. Trigger network 400 may be generated by, for example, compiler 216, and may correspond to a condition defined as:

$$𝒞 ≡ ( ∃ {T}_{1} {v}_{1} ) ( ∃ {T}_{2} {v}_{2} ) ( ∃ {T}_{3} {v}_{3} ) {v}_{1} \cdot x = 3 ( {v}_{1} \cdot y = {v}_{2} \cdot y {v}_{2} \cdot x = 5 ) \qquad ( 13 )$$

The condition defined by Equation 13 may be more complex than the condition defined by Equation 12, which may thus cause trigger network 400 to include additional components compared to trigger network 300. For example, equation 13 may include a disjunction, Trigger network 400 may include source nodes 402, 404, 406: filter operators 408, 410, 412, and 414; join operators 416, 418, and 420; and Cartesian product operators 422, 424, and 426. Components of trigger network 400 may be connected by using branches 428, 430, 432, 434, 436, 438, 440, 442, 444, 446, 448, 450, 452, 454, 456, 458, and 460. Join operators 418 and 420 may include multiple outputs as indicated by dashed branches 446, 448, an 460. The multiple outputs correspond to left inhibitor outputs, match outputs, and right inhibitor outputs of join operators 418 and 420.

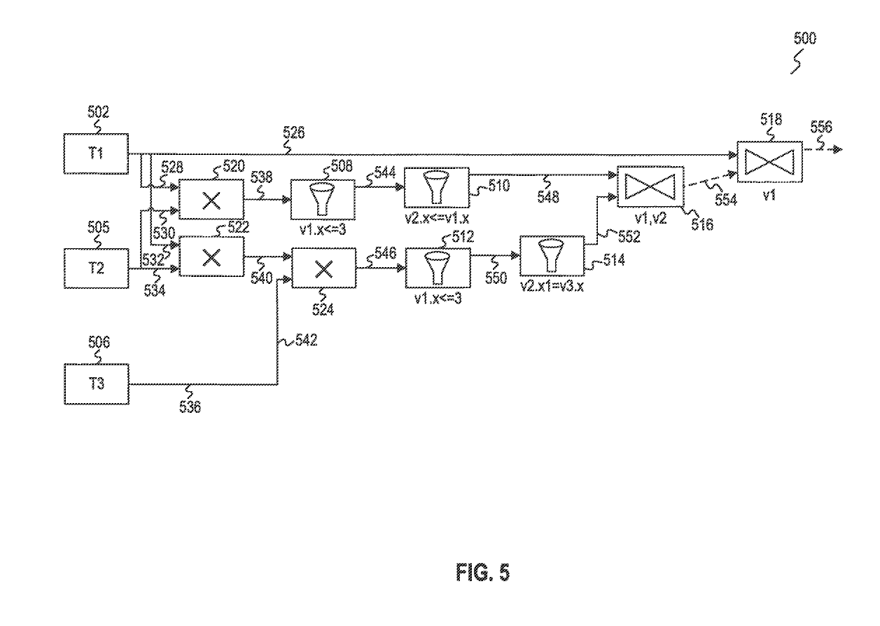

FIG. 5 illustrates an exemplary trigger network 500 that may be used to evaluate a condition included in an additional ECA rule. Trigger network 500 may be generated by, for example, compiler 216, and may correspond to a condition defined as:

$$𝒞 ≡ ( ∃ {T}_{1} {v}_{1} ) ( ∀ {T}_{2} {v}_{2} ) ( ∀ {T}_{3} {v}_{3} ) ( {v}_{1} \cdot x > 3 {v}_{2} \cdot x > {v}_{1} \cdot x ) ( {v}_{1} \cdot x > 3 {v}_{1} \cdot x = {v}_{3} \cdot x ) ≡ ( ∃ {T}_{1} {v}_{1} ) ( ∄ {T}_{2} {v}_{2} ) ( {v}_{1} \cdot x \leq 3 {v}_{2} \cdot x \leq {v}_{1} \cdot x ) ( ∃ {T}_{3} {v}_{3} ) ( {v}_{1} \cdot x \leq 3 {v}_{1} \cdot x \neq {v}_{3} \cdot x ) \qquad ( 14 )$$

The condition defined by Equation 14 may also be more complex than the condition defined by Equation 12, which may cause trigger network 500 to include additional components compared to trigger network 300. For example, equation 14 may include universal quantification or “forall” quantifiers. Trigger network 500 may include source nodes 502, 504, 506; filter operators 508, 510, 512, and 514; join operators 516 and 518; and Cartesian product operators 520, 522, and 524. Components of trigger network 500 may be connected by using branches 526, 528, 530, 532, 534, 536, 538, 540, 542, 544, 546, 548, 550, 552, 554, and 556. Join operator 516 may include multiple outputs as indicated by dashed branches 554.

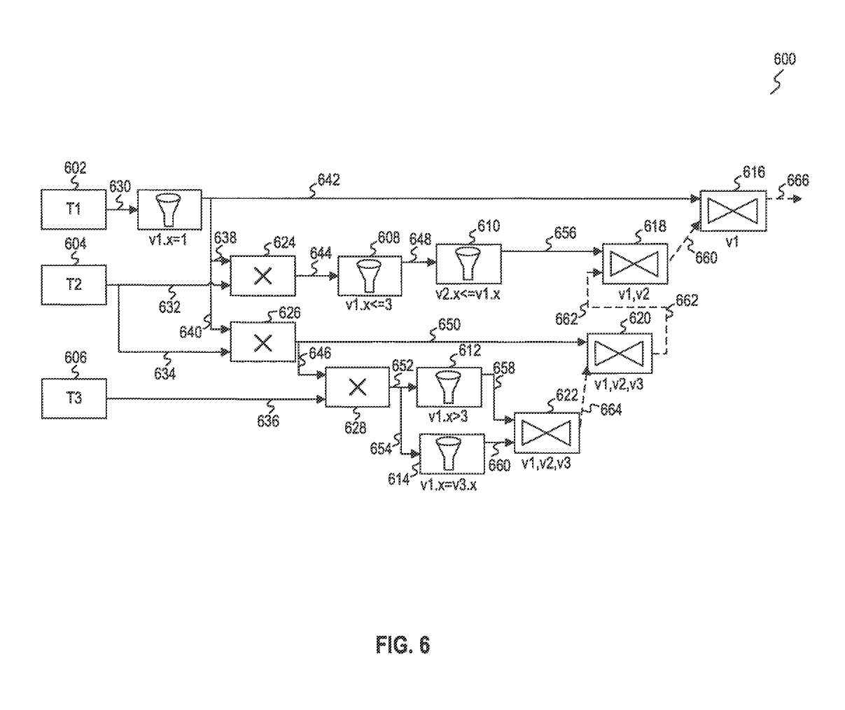

FIG. 6 illustrates an exemplary trigger network 600 that may be used to evaluate a condition included in an additional ECA rule, Trigger network 600 may be generated by, for example, compiler 216, and may correspond to a condition defined as:

$$𝒞 ≡ ( ∃ {T}_{1} {v}_{1} ) ( ∀ {T}_{2} {v}_{2} ) ( ∃ {T}_{3} {v}_{3} ) ( {v}_{1} \cdot x = 1 ) ( {v}_{1} \cdot x > 3 {v}_{2} \cdot x > {v}_{1} \cdot x ) ( {v}_{1} \cdot x > 3 {v}_{1} \cdot x = {v}_{3} \cdot x ) ≡ ( ∃ {T}_{1} {v}_{1} ) ( {v}_{1} \cdot x = 1 ) ( ∀ {T}_{2} {v}_{2} ) ( {v}_{1} \cdot x > 3 {v}_{2} \cdot x > {v}_{1} \cdot x ) ( ∃ {T}_{3} {v}_{3} ) ( {v}_{1} \cdot x > 3 {v}_{1} \cdot x = {v}_{3} \cdot x ) ≡ ( ∃ {T}_{1} {v}_{1} ) ( {v}_{1} \cdot x = 1 ) ( ∄ {T}_{2} {v}_{2} ) ( {v}_{1} \cdot x \leq 3 {v}_{2} \cdot x \leq {v}_{1} \cdot x ) ( ∄ {T}_{3} {v}_{3} ) ( {v}_{1} \cdot x > 3 {v}_{1} \cdot x = {v}_{3} \cdot x ) \qquad ( 15 )$$

The condition defined by Equation 4 may also be more complex than the conditions defined by Equations 1, 2, and 3, which may thus cause trigger network 600 to include additional components compared to trigger networks 300, 400, and 500. For example, trigger network 600 may include source nodes 602, 604, 606; filter operators 608, 610, 612, 614, and 616; join operators 618, 620, 622, and 624; and Cartesian product operators 626, 628, and 630. Components of trigger network 600 may be connected by using branches 632, 634, 636, 638, 640, 642, 644, 646, 648, 650, 652, 654, 656, 658, 660, 662, 664, 666, 668, and 670. Join operators 620, 622, and 624 may include multiple outputs as indicated by dashed branches 664, 666, and 668, respectively,

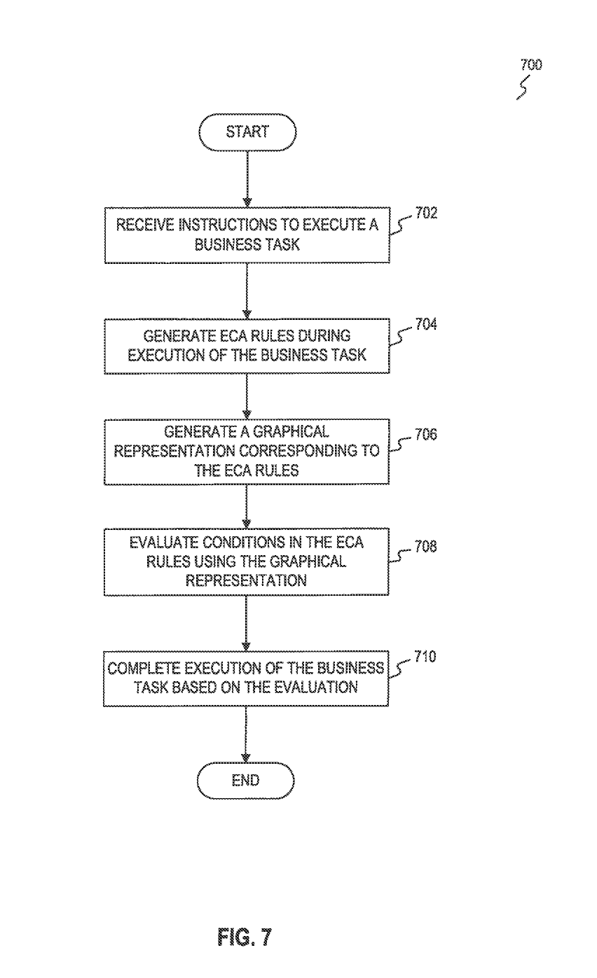

FIG. 7 is a flow diagram of a process 700 for performing a business task based on optimized evaluation of ECA rules, consistent with the invention. Process 700 may be implemented by using user device 204a or other systems known to those of skill in the art. The process may begin in step 702 where instructions are received regarding execution of a business task. The instructions may be received by, for example, user device 204a and may include input parameters and/or workflow models describing the business task. The business task may be, for example, storing data objects in a database table after checking internal constraints of the database table. Next, in step 704, ECA rules may be generated during execution of the business task. The ECA rules may be generated when, for example, processor 220 executes application program 214 to perform a business task. The ECA rules may also be provided by a user.

In step 706, a graphical representation may be generated based on the ECA rules generated in step 704. The graphical representation may be a trigger network and may be generated by, for example, compiler 216. Next, in step 708, conditions in the ECA rules may be evaluated based on the graphical representation. In step 710, execution of the business task may be completed based on the evaluation of the conditions, and the process may end.

The foregoing description of possible implementations consistent with the present invention does not represent a comprehensive list of all such implementations or all variations of the implementations described. The description of only some implementations should not be construed as an intent to exclude other implementations. One of ordinary skill in the art will understand how to implement the invention in the appended claims in many other ways, using equivalents and alternatives that do not depart from the scope of the following claims.

The systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus. For example, various general-purpose machines may be used with programs written in accordance with teachings of the invention, or it may be more convenient to construct a specialized apparatus or system to perform the required methods and techniques.

Systems and methods consistent with the present invention also include computer readable storage media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

What is claimed is:

1. A method of executing a business task, the method being implemented by a computer system and comprising the steps of:
receiving an instruction to execute a business task;
generating an event-condition-action (ECA) rule during execution of the business task;
generating a graphical representation corresponding to the ECA rule; and
executing, using a processor of the computer system, the business task based on an evaluation of the graphical representation.

2. The method of claim 1, wherein the instruction is a workflow model generated by using Business Process Modeling Notation.

3. The method of claim 1, wherein the graphical representation is a trigger network.

4. The method of claim 1, wherein the evaluation includes resolving the condition in the ECA rule by using the trigger network.

5. The method of claim 1, wherein the graphical representation includes a source node representing an event in the ECA rule, an operator node representing a condition in the ECA rule, and an action node representing an action in the ECA rule.

6. The method of claim 5, wherein the operator node is one of a filter operator, a join operator, a Cartesian product, or a swizzle operator.

7. The method of claim 1, wherein a condition in the ECA rule includes a plurality of variables.

8. The method of claim 7, wherein the plurality of variables correspond to different data types.

9. The method of claim 7, wherein the plurality of variables includes a plurality of instances of different types.

10. A computer-readable storage medium comprising instructions, which when executed on a processor, cause the processor to perform a method of executing a business task, the method comprising:
receiving an instruction to execute a business task;
generating an event-condition-action (ECA) rule during execution of the business task;
generating a graphical representation corresponding to the ECA rule; and
executing, using a processor of the computer system, the business task based on an evaluation of the graphical representation.

11. The computer-readable storage medium of claim 10, wherein the instruction is a workflow model generated by using Business Process Modeling Notation.

12. The computer-readable storage medium of claim 10, wherein the graphical representation is a trigger network.

13. The computer-readable storage medium of claim 12, wherein the evaluation includes resolving a condition in the ECA rule by using the trigger network.

14. The computer-readable storage medium of claim 10, wherein the graphical representation includes a source node representing an event in the ECA rule, an operator node representing a condition in the ECA rule, and an action node representing an action in the ECA rule.

15. The computer-readable storage medium of claim 14, wherein the operator node is one of a filter operator, a join operator, a Cartesian product, or a swizzle operator.

16. The computer-readable storage medium of claim 10, wherein a condition in the ECA rule includes a plurality of variables.

17. The computer-readable storage medium of claim 16, wherein the plurality of variables correspond to different data types.

18. A computer-implemented system of executing a business task comprising:
a memory device having instructions; and
a processor executing the instructions to perform the steps of:
receiving an instruction to execute a business task;
generating an event-condition-action (ECA) rule during execution of the business task;
generating a graphical representation corresponding to the ECA rule; and
executing, through use of the processor, the business task based on an evaluation of the graphical representation.

19. The system of claim 18, wherein the graphical representation is a trigger network, and the evaluation includes resolving a condition in the ECA rule by using the trigger network.
